(19) United States
(12) Patent Application Publication
(10) Pub. No.: US 2014/0272135 A1
(43) Pub. Date: Sep. 18, 2014

(54) DEPOSITION INJECTION MASKING

(71) Applicant: TAIWAN SEMICONDUCTOR MANUFACTURING COMPANY LIMITED, Hsin-Chu (TW)

(72) Inventors: Chih-Chiang Chang, Zhubei City (TW); Yi-Nien Su, Hsinchu City (TW); Su-Jen Sung, Zhubei City (TW); Chao-Chun Wang, Hsinchu City (TW); Hsiang-Wei Lin, New Taipei City (TW)

(21) Appl. No.: 13/795,901

(22) Filed: Mar. 12, 2013

(51) Int. Cl. B05B 15/04

(52) U.S. Cl. CPC B05B 15/045
USPC 427/248.1; 118/720; 118/504

(57) ABSTRACT

In deposition devices, a precursor is directed at a substrate within a deposition chamber, and a block plate comprising a set of block plate apertures adjusts the direction and volume of the outflowing precursor. However, arrangements of block plate apertures that are suitable for some deposition scenarios (such as one type of precursor) are unsuitable for other deposition scenarios, resulting in precursor deposition that is undesirably thick, thin, or inconsistent. A set of block plate masks positioned over respective zones of the block plate are adjustable to align a set of masking apertures with respect to the block plate apertures, such as by operating a block plate motor to rotate a ring-shaped block plate mask over a cylindrical zone of the block plate. This configuration enables adjustable exposure of the block plate apertures to control the adjusted outflow of precursor through the block plate.

### BACKGROUND

The present disclosure is related to deposition devices and techniques, wherein a substrate is positioned within a deposition chamber and exposed to a series of precursors to form microscopically thin layers of deposited material.

### SUMMARY

This Summary is provided to introduce a selection of concepts in a simplified form that are further described below in the detailed description. This summary is not intended to be an extensive overview of the claimed subject matter, identify key factors or essential features of the claimed subject matter, nor is it intended to be used to limit the scope of the claimed subject matter.

In many scenarios, deposition is typically performed by injecting a gaseous or vaporous precursor toward a substrate positioned within a deposition chamber. In order to control the distribution of the precursor over the surface of the substrate, a block plate is positioned between the substrate source and the substrate, where the block plate comprises an array of block plate apertures that permit passage of the precursor to specific locations of the surface of the substrate. While the use of a block plate improves such distribution, the block plate is typically disposed within the deposition device in a fixed location and orientation, and with a symmetry or uniformity of the distribution of the block plate apertures over the block plate. This fixed position and uniform of the block plate apertures results in only one option for controlling the injection of the precursor at the substrate. In some cases, a pattern of block plate apertures, used with some precursors, injection patterns, and substrates, results in an uneven distribution of precursors. However, altering the distribution pattern often involves manually replacing the block plate with an alternative block plate having a different distribution of block plate apertures.

The present disclosure involves placing a set of block masks between the precursor source and the block plate, where the block mask comprises an array of masking apertures that, for a particular zone of the block plate, are alignable in various ways with the block plate apertures within the zone of the block plate. For example, a ring-shaped block mask, when positioned over a ring-shaped zone of the block plate, enables the selection of the alignment of the masking apertures and the block plate apertures by rotating the block mask ring. Options achievable by different alignments include exposing a variable arrangement of block plate apertures, and selecting block plate apertures with different block plate aperture profiles. The selecting and exposing a subset of the block plate apertures of the block plate through the positioning of the block mask over the block plate enable greater process control and, in some circumstances, greater distribution consistency of the deposited precursor across the surface of the substrate.

To the accomplishment of the foregoing and related ends, the following description and annexed drawings set forth certain illustrative aspects and implementations. These are indicative of but a few of the various ways of embodying one or more aspects of the presented techniques. Other aspects, advantages, and novel features of the disclosure will become apparent from the following detailed description when considered in conjunction with the annexed drawings.

### DESCRIPTION OF THE DRAWINGS

Aspects of the disclosure are understood from the following detailed description when read with the accompanying drawings. It will be appreciated that elements and structures of the drawings are not necessarily be drawn to scale. Accordingly, the dimensions of the various features is arbitrarily increased and reduced for clarity of discussion.

FIG. 1 is an illustration of an exemplary deposition device.

FIG. 2 is an illustration of an exemplary deposition device including an adjustable block mask in accordance with the techniques presented herein.

FIG. 3 is a chart illustrating the distribution of a precursor over the surface of a substrate in a first deposition device not having a block plate and a second deposition device having a block plate.

FIG. 4 is a flow chart illustrating an exemplary method of directing a precursor at a substrate positioned within a deposition chamber in accordance with the techniques presented herein.

FIG. 5 is an illustration of an exemplary computer-readable storage medium storing instructions configured to cause a computing device to perform the techniques presented herein.

FIG. 6 is an illustration of an exemplary configuration of three exemplary variations in the distribution of block plate apertures of a block plate.

FIG. 7 is an illustration of various profiles of block plate apertures, and various alignments of masking apertures and block plate apertures.

### DETAILED DESCRIPTION

Embodiments or examples, illustrated in the drawings, are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

FIG. 1 presents an illustration of an exemplary deposition technique for forming a layer on a substrate. In this exemplary scenario, a deposition chamber 102 includes a substrate stage 106 on which is positioned a substrate 104. The precursor 110 is stored by a precursor source 108 that is controllably connected with the deposition chamber 102, such as through a controllable inlet that, when opened, enables an outflow 112 of the precursor 110 into the deposition chamber 102. In order to direct the outflow 112 toward the substrate 104 and to provide consistent distribution of the outflow 112 of the precursor 110 toward the substrate 104, a block plate 104 is positioned therebetween, comprising a set of block plate apertures 116 through which of the precursor 110 of the outflow 112 is toward the substrate 104. The adjusted outflow 118 emitting from the block plate 114 is more controllably directed toward the substrate 104.

While the inclusion of a block plate 114 improves the guidance of the outflow 112 toward the substrate 104, the deposition device depicted in the exemplary scenario 100 of FIG. 1 presents some limitations due to the fixed configuration of block plate apertures 116 in the block plate 114. For some selected precursors 110, a single configuration of block plate apertures 116 results in uneven distribution of the selected precursor 110 toward the substrate 104, and a fixed flow rate of the adjusted outflow 118. Additionally, changing the configuration of block plate apertures 116 often involves a manual substitution of the block plate 114 with a second block plate 114 having a different configuration of block plate apertures 116, which is time-consuming, not amenable to automation, and not feasible for the exposure of a single substrate 104 to different precursors 110 utilizing different block plates 114 having different configurations of block plate apertures 116.

Presented herein are techniques for varying the adjusted outflow 118 provided by the block plate 114 through the inclusion of a block mask set, positioned in the deposition device between the precursor source 108 and the block plate 114, and comprising a series of block masks that controllably vary the adjusted outflow 118 generated by the block plate 114. Respective block masks overlap a portion of the block plate 114, herein termed a “zone,” such that an adjustment of the position of the block mask results in variable exposure of the block plate apertures 116 within the zone of the block plate 114 covered by the block mask. For example, in a first selected alignment, the masking apertures and the block plate apertures 116 of the corresponding zone are completely aligned, such that the adjusted outflow 118 emitting from the block plate 114 is not affected by the presence of the block mask. However, in a second selected alignment, the masking apertures partially masking the block plate apertures 116 in the zone of the block plate 114 (either by partially occluding each bock plate aperture 116, or by exposing some of the block plate apertures 116 and completely occluding other block plate apertures 116), thus reducing the adjusted outflow 118 from the block plate 114 as compared with the first selected alignment. Some such alignments also alter the angle, shape, or profile of the adjusted outflow 118 emitting through the block plate apertures 116. In a third selected alignment, the masking apertures are aligned such that no block plate apertures 116 are exposed, thus fully blocking the adjusted outflow 118 through this zone 208 of the block plate 114. In this manner, the selectable alignment of the block masks 204 provides tighter control of the adjusted outflow 118 emitting from the block plate 114 by permitting, reducing, shaping, or blocking the adjusted outflow 118. Moreover, the inclusion of a block mask motor to adjust the position of the block mask over the zone enables an automated adjustment of the components of the deposition device.

FIG. 2 presents an illustration of an exemplary scenario 200 depicting a deposition device having an adjustable adjusted outflow 118 of the precursor 110 directed at the substrate 104 through the inclusion of a block mask set 202 comprising a series of block masks 204 respectively having a set of masking apertures 206. In this exemplary scenario 200, the block masks 204 are provided as a set of rings, each positioned to cover a zone 208 of the block plate 114 (which, in this exemplary scenario 200 are not necessarily physically demarcated on the block plate 114, but are simply the portion of the block plate 114 covered by the block mask 204). For respective block plates 204, a position 210 is selectable (in this exemplary scenario 200, by rotating the ring-shaped block mask 204) to select an alignment 212 of the masking apertures 206 and the block plate apertures 116, such as fully exposing all of the masking apertures 206; partially occluding the masking apertures 206 in order to reduce the adjusted outflow 118 or to alter its shape; and fully occluding the masking apertures 206. In this manner, the selection of a position 210 of each block mask 204 achieves a selected alignment 212 of the masking apertures 206 and the block plate apertures 116 affecting the adjusted outflow 118 directed through the zone 208 of the block plate 114 toward the substrate 104, without having to access or swap the block plate 114.

FIG. 3 presents a chart 300 depicting some experimental results demonstrating the deposition profile of a substrate 104 with precursor 110 when directed through a block plate 114 with and without the use of a block mask set 202. In this chart 300, a target deposition profile of 1.00 is desirable, but a first data set 302 illustrating the achieved deposition profile using only a fixed block plate 114 illustrates various peaks and troughs, reflecting the distribution of block plate apertures 116 over the block plate 114. However, a second data set 304 illustrating the achieved deposition profile using a block mask set 202 of blocking masks 204 illustrates a first reduction 308 of the peaks and a second reduction 310 of the troughs depicted in the first data set 302. This chart 300 thus reveals an achievable advantage of including the blocking mask set 202 to render increased consistency in the adjusted outflow 118 of precursor 110 directed at the substrate 104 positioned within the deposition chamber 102.

FIG. 4 presents an illustration of an exemplary method 400 of depositing a layer on a surface of a substrate 104 in accordance with the techniques presented herein. The exemplary method 400 involves a deposition device comprising a precursor source 108 storing a precursor 110; a block plate 114 comprising block plate apertures 116 directing injection of the precursor 110 at the substrate 104; and at least one block mask 204 comprising masking apertures 206 and positioned to cover a zone 208 of the block plate 114. The exemplary method 400 involves positioning 402 the respective block masks 204 over the zone 208 of the block plate 114 to achieve a selected alignment 212 of the masking apertures 116 and the block plate apertures 206. The exemplary method 400 also involves directing 404 the precursor 110 from the precursor source 108 through the masking apertures 206 and exposed block plate apertures 116 toward the substrate 104. In this manner, the exemplary method 400 achieves the adjustable direction of the precursor 110 toward the aperture 104 in the deposition device.

Still another embodiment involves a computer-readable medium comprising processor-executable instructions configured to implement one or more of the techniques presented herein. An example embodiment of a computer-readable medium or a computer-readable device that is devised in these ways is illustrated in FIG. 5, wherein an implementation 500 comprises a computer-readable medium 502, such as a CD-R, DVD-R, flash drive, a platter of a hard disk drive, etc., on which is encoded computer-readable data 504. This computer-readable data 506, such as binary data comprising a plurality of zeroes and ones, in turn comprises a set of computer instructions 506 configured to operate according to one or more of the principles set forth herein. In an embodiment 500, the processor-executable computer instructions 506 are configured to perform a method, such as at least some of the exemplary method 400 of FIG. 4. Many such computer-readable media are devised by those of ordinary skill in the art that are configured to operate in accordance with the techniques presented herein.

Some variations of respective aspects of the techniques presented herein enable additional advantages and/or reduce disadvantages as compared with other such variations of the techniques presented herein and/or other techniques.

A first aspect having respective variations among embodiments involves the positioning of the block plate 114 and the block mask set 202 within a deposition device. As one variation, the deposition device further comprises a deposition chamber lid, and the precursor source 108 controllably injects the precursor 110 downward through the deposition chamber lid. In such embodiments, the block plate 114 is positioned in the deposition chamber lid, and the block masks 204 are positioned above the block plate 114 in the deposition chamber lid, such that the precursor source 108 injects the precursor 110 downward through the block masks 202 and the block plate 114 within the deposition chamber lid in order to inject the adjusted outflow 118 into the deposition chamber 102. In other variations, the block mask set 202 and the block plate 114 are positioned (together or separately) in other portions of the deposition device.

A second aspect having respective variations among embodiments involves the shape and selectable positions 210 of the block masks 204 of the block mask set 202. As a first variation, the block plate 114 comprises a first disc, and at least one block mask 204 comprises a second disc positioned to cover a circular zone 208 of the block plate 114 and rotatable to select an alignment 212 of the masking apertures 206 with the block plate apertures 116 in the circular zone 208 of the block plate 114. In the particular example depicted in the exemplary scenario 200 of FIG. 2, the zones 208 of the block plate 114 comprise a number of concentric rings, and the block masks 204 also comprise concentric rings respectively positioned over a selected concentric ring of the block plate 114, and independently rotatable to select an alignment 212 of the masking apertures 206 of the block mask 204 and the block plate apertures 116 in the selected concentric ring of the block plate 114. A second variation involves a block mask set 202 comprising a grid of independent, substantially square block masks 204 arrayed as a grid and overlapping an array of grid regions comprising the zones 208 of the block plate 114, and where the selection 210 comprises laterally shifting respective substantially square block masks 204 to alter the alignment 212 of the masking apertures 206 with the block plate apertures 116 in the overlapped grid region of the block plate 208. Many such configurations of block masks 204 and zones 208 of the block plate 114 are compatible with the techniques presented herein.

A third aspect having respective variations among embodiments involves the distribution of the masking apertures 206 over the block mask 204. FIG. 2 depicts that the distribution of the masking apertures 206 having approximately the number and position of masking apertures 206 as the block plate apertures 106. FIG. 6 depicts three such variations, including a first variation 602 in which the masking apertures 206 are distributed in a spiral pattern; a second variation 604 in which the masking apertures 206 are distributed in a radial pattern; and a third variation 606 in which the masking apertures are distributed in a polar pattern.

A fourth aspect having respective variations among embodiments involves the manner of selecting the position 210 of the block masks 204 with the zone 208 of the block plate 114. In a first such example, a block mask motor is included and operable to rotate the block mask 204 to achieve a selected alignment of the masking apertures 206 of the block mask 204 and the block plate apertures 116 of the block plate 114. In a second such example, the positions 210 of the block masks 204 are manually selectable, such as through levers or dials providing manual adjustment of the position of a block mask 204 with respect to the zone 208 of the block plate 114.

A fifth aspect having respective variations among embodiments involves the design of the masking apertures 206 and the block plate apertures 604. As a first variation of this fifth aspect, both sets of apertures have various lateral diameters. A lateral diameter of approximately 0.7 millimeters for the masking aperture 206 and the block plate apertures 116 is well-suited for the flow of some precursors 110.

As a second variation of this fifth aspect, the number, positioning, and spacing of the masking apertures 206 and block plate apertures 116 enables various alignments 212 selectable through various positions 210 of the block masks 204. FIG. 6 further presents an exemplary scenario 600 featuring one such example, wherein the alignments 212 comprise a variable arrangement of block plate apertures 116 exposed by the masking apertures 206. A first alignment 212 is achieved by rotating the block mask 204 over a first position 604 within the zone 208 of the block plate 114, such that the masking apertures 206 are fully exposed. Other alignments 212, achieved by rotating the block mask 204 over other positions 604 within the zone 208 of the block plate 114, partially expose or fully obstruct the block plate apertures 116, thus providing other adjusted outflows 118 of the precursor 110 through the block plate 114. Other arrangements of block plate apertures 116 and masking apertures 206 (such as a spiral arrangement of block plate apertures 116) enable other selectable alignments 212 having various properties, such as a variable arrangement of exposed block plate apertures 116 at various selectable alignments 212.

As a third variation of this fifth aspect, the masking apertures 206 are formed through the block mask 204 with various masking aperture profiles; and similarly, the block plate apertures 116 are formed through the block plate 114 with various block plate aperture profiles. FIG. 7 depicts various block plate aperture profiles, such as a cone block plate aperture profile; a horn block plate aperture profile; and a cylindrical block plate aperture profile. The masking apertures 206 also present a cone masking aperture profile; a horn masking aperture profile; and a cylindrical masking aperture profile. Respective aperture profiles affect the alteration of the adjusted outflow 118 of the precursor 110, such as the shape and volume of the adjusted outflow 118. Additionally, the adjusted outflow 118 is affected by the combined shape formed by the alignment 212 of the masking aperture 206 and the block plate aperture 116. As a first example, as further illustrated in the exemplary scenario 700 of FIG. 7, the flow of precursor 110 through a first masking aperture 206 and an aligned block plate aperture 116 having a conical block plate aperture profile provides a first conical adjusted outflow 110 provides different dispersal (broader or narrower) than a second masking aperture 206 and an aligned block plate aperture 116 having a horn block plate aperture profile. However, it is desirable to select the profiles of the masking apertures 206 and the alignment 212 to match the profiles of the block plate apertures 116. For example, with respect to a surface lateral diameter of the block plate aperture profile on the surface of the block plate 114 facing the block mask 204, and it is desirable to form the masking apertures 206 and to align the masking apertures 206 to present a lateral diameter on the surface of the block mask 204 facing the block plate 114 that matches the surface lateral diameter of the block plate aperture profile. As further illustrated in the exemplary scenario 700 of FIG. 7, in the first two alignments 212, the position and width of the profile of the masking aperture 206 are aligned 702 with the position and width of the profile of the block plate aperture 116. However, in a third alignment 212, the profile of the masking aperture 206 is misaligned 706 with the position of the block plate aperture 116, creating a dead space in the block plate aperture 116 that creates eddies 704 in the flow of the precursor 110 through the block plate 114 that disrupts the consistency of the adjusted outflow 118 of the precursor 110. Such eddies 704 are avoidable by forming and aligning the profiles of the masking apertures 206 to match the profiles of the block plate apertures 116.

A first embodiment of the techniques provided herein comprises a deposition device, comprising a deposition chamber, a substrate stage positioning a substrate within the deposition chamber, a precursor source controllably injecting a precursor into the deposition chamber, and a block plate comprising block plate apertures directing injection of the precursor at the substrate. In accordance with the techniques provided herein, the first embodiment further comprises at least one block mask comprising masking apertures and positioned to cover a zone of the block plate with an alignment of the masking apertures and the block plate apertures to alter directing the injection of the precursor at the substrate.

A second embodiment of the techniques provided herein comprises a block mask set usable with a deposition device comprising a deposition chamber, a substrate stage positioning a substrate within the deposition chamber, a precursor source controllably injecting a precursor into the deposition chamber, and a block plate comprising block plate apertures directing injection of the precursor at the substrate. In accordance with the techniques provided herein, the block mask set comprises at least one block mask comprising masking apertures and positioned to cover a zone of the block plate with an alignment of the masking apertures and the block plate apertures to alter directing the injection of the precursor at the substrate.

A third embodiment of the techniques provided herein comprises a method of exposing a substrate to a precursor in a deposition device comprising a precursor source storing a precursor, a block plate comprising block plate apertures directing injection of the precursor at the substrate, and at least one block mask comprising masking apertures and positioned to cover a zone of the block plate. In accordance with the techniques provided herein, the method comprises positioning respective block masks over the zone of the block plate to achieve a selected alignment of the masking apertures and the block plate apertures, and injecting the precursor from the precursor source through the masking apertures and exposed block plate apertures toward the substrate.

Although the subject matter has been described in language specific to structural features and/or methodological acts, it is to be understood that the subject matter of the appended claims is not necessarily limited to the specific features or acts described above. Rather, the specific features and acts described above are disclosed as example forms of implementing the claims.

Various operations of embodiments are provided herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

It will be appreciated that layers, features, elements, etc. depicted herein are illustrated with particular dimensions relative to one another, such as structural dimensions and/or orientations, for example, for purposes of simplicity and ease of understanding and that actual dimensions of the same differ substantially from that illustrated herein, in some embodiments. Additionally, a variety of techniques exist for forming the layers, features, elements, etc. mentioned herein, such as implanting techniques, doping techniques, spin-on techniques, sputtering techniques such as magnetron or ion beam sputtering, growth techniques, such as thermal growth and/or deposition techniques such as chemical vapor deposition (CVD), for example.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims.

What is claimed is:

1. A deposition device, comprising:
a deposition chamber;
a substrate stage positioning a substrate within the deposition chamber;
a precursor source controllably injecting a precursor into the deposition chamber;
a block plate comprising block plate apertures directing injection of the precursor at the substrate; and
at least one block mask comprising masking apertures and positioned to cover a zone of the block plate with an alignment of the masking apertures and the block plate apertures to alter directing the injection of the precursor at the substrate.

2. The deposition device of claim 1:
the deposition device further comprising a deposition chamber lid;
the precursor source controllably injecting the precursor downward through the block plate positioned in the deposition chamber lid; and
the at least one block mask positioned above the block plate in the deposition chamber lid.

3. The deposition device of claim 1:
the block plate comprising a first disc; and
at least one block mask comprising a second disc positioned to cover a circular zone of the block plate and rotatable to select an alignment of the masking apertures with the block plate apertures in the circular zone of the block plate.

4. The deposition device of claim 3:
respective circular zones of the block plate comprising a concentric ring; and
the block masks comprising concentric rings respectively positioned over a selected concentric ring of the block plate and independently rotatable to select an alignment of the masking apertures of the block mask and the block plate apertures of the selected concentric ring of the block plate.

5. The deposition device of claim 1, further comprising: a block mask motor configured to position the block mask to select the alignment of the masking apertures and the block plate apertures.

6. The deposition device of claim 1, the masking apertures and the block plate apertures having a lateral diameter of approximately 0.7 millimeters.

7. The deposition device of claim 1, respective alignments of the masking apertures and the block plate apertures comprising a variable arrangement of the block plate apertures exposed by the masking apertures.

8. The deposition device of claim 1, respective masking apertures having a cylindrical masking aperture profile.

9. The deposition device of claim 8:
respective block plate apertures comprising a block plate aperture profile; and
the cylindrical masking aperture profile selected to match the block plate aperture profiles of the block plate apertures.

10. The deposition device of claim 9:
the block plate aperture profile having a surface lateral diameter for a surface of the block plate facing the block mask; and
the cylindrical masking aperture having a lateral diameter matching the surface lateral diameter of the block plate aperture profile.

11. A block mask set usable with a deposition device, the deposition device comprising:
a deposition chamber,
a substrate stage positioning a substrate within the deposition chamber, a precursor source controllably injecting a precursor into the deposition chamber, and
a block plate comprising block plate apertures directing injection of the precursor at the substrate,
the block mask set comprising: at least one block mask comprising masking apertures and positioned to cover a zone of the block plate with an alignment of the masking apertures and the block plate apertures to alter directing the injection of the precursor at the substrate.

12. The block mask set of claim 11:
the zones of the block plate comprising a number of concentric rings; and
respective block masks of the block mask set comprising concentric rings respectively positioned over a concentric ring of the block plate and independently rotatable to select an alignment of the masking apertures of the block mask and the block plate apertures of the concentric ring of the block plate.

13. The block mask set of claim 11, the masking apertures having a lateral diameter of approximately 0.7 millimeters.

14. The block mask set of claim 11, respective masking apertures having a cylindrical masking aperture profile.

15. The block mask set of claim 14:
respective block plate apertures comprising a block plate aperture profile; and
the cylindrical masking aperture profile selected to match the block plate aperture profiles of the block plate apertures.

16. The block mask set of claim 15:
the block plate aperture profile having a surface lateral diameter for a surface of the block plate facing the block mask; and
the cylindrical masking aperture having a lateral diameter matching the surface lateral diameter of the block plate aperture profile.

17. A method of exposing a substrate to a precursor in a deposition device comprising:
a precursor source storing a precursor;
a block plate comprising block plate apertures directing injection of the precursor at the substrate; and
at least one block mask comprising masking apertures and positioned to cover a zone of the block plate,
the method comprising:
positioning respective block masks over the zone of the block plate to achieve a selected alignment of the masking apertures and the block plate apertures; and
injecting the precursor from the precursor source through the masking apertures and exposed block plate apertures toward the substrate.

18. The method of claim 17:
the deposition device comprising a block mask motor configured to position the block mask to select an alignment of the masking apertures and the block plate apertures; and
positioning the respective block masks over the zone of the block plate comprising: operating the block mask motor to select a position of the block mask over the mask plate achieving the selected alignment of the masking apertures of the block mask and the block plate apertures of the zone of the block plate.

19. The method of claim 17:
respective alignments of the masking apertures and the block plate apertures comprising a variable arrangement of the block plate apertures exposed by the masking apertures; and
positioning the respective block masks over the zone of the block plate comprising: positioning the block mask over the zone of the block plate to expose a selected number of block plate apertures by the masking apertures.

20. The method of claim 17:
respective masking apertures having a masking aperture profile;
respective block plate apertures comprising a block plate aperture profile; and
positioning the respective block masks over the zone of the block plate comprising: positioning the block mask over the zone of the block plate to the match the masking aperture profile of respective masking apertures with the block plate aperture profile of the block plate aperture.
